(19) United States
(12) Patent Application Publication
(10) Pub. No.: US 2003/0214953 A1
(43) Pub. Date: Nov. 20, 2003

(54) Networked magnetic resonance imaging system and method incorporating same

(75) Inventors: Mohamed El-Demerdash, Milwaukee, WI (US); Rebecca A. McCann, Hartland, WI (US); Philip J. Bylsma, Brookfield, WI (US); Jacqueline A. Budde, Hartland, WI (US)

Correspondence Address: FLETCHER, YODER & VAN SOMEREN, P. O. BOX 692289, HOUSTON, TX, 77269-2289, US

(73) Assignee: GE Medical Systems Global Technology Company, LLC, Waukesha, WI

(21) Appl. No.: 10/063,798

(22) Filed: May 14, 2002

(51) Int. Cl. H04L 12/56

(52) U.S. Cl. 370/400; 370/466; 370/241; 370/216

(57) ABSTRACT

The present technique provides a system and method for controlling, communicating with, and generally managing imaging subsystems and peripheral devices. The technique is applicable to a wide range of imaging systems, but is particularly well suited to complex imaging systems used in the medical diagnostics field. In the field of medical diagnostic imaging systems, the technique has particular promise for controlling, communicating with, and generally managing subsystems and devices in MRI systems, CT systems, x-ray systems, PET systems, and so forth. In a general sense, the technique facilitates more efficient and reliable communication with the subsystems and peripheral devices of the medical imaging system. For example, the present technique may use a CAN or CAN OPEN network architecture to provide uniform communication with the subsystems and peripheral devices and to provide a variety of operational checks to ensure the operational reliability of the imaging system.

### BACKGROUND OF INVENTION

The present invention relates generally to the field of imaging systems including one or more peripheral devices, such as systems used in the medical diagnostics field. More particularly, the invention relates to a technique for managing peripheral devices in an imaging system using a network scheme having uniform communication protocols and device management features.

A wide variety of imaging systems have been developed and are presently in use, particularly in the medical diagnostics field. While very simple imaging systems may comprise self-contained image acquisition and processing components and circuitry, more complex systems include various peripheral devices that may be associated with other system components. In the medical imaging field, for example, systems are typically considered by imaging modality. These modalities may include magnetic resonance imaging (MRI) systems, computed tomography (CT) systems, ultrasound systems, x-ray systems, positron emission tomography (PET) systems, and so forth. Depending upon the physics involved in acquiring and reconstructing useful images, these systems call upon different control and processing circuitry, as well as peripheral devices for data acquisition, processing, storage, and output or viewing.

By way of example, in an MRI system, image data is acquired by imposing magnetic fields on a subject, including a primary magnetic field and a series of gradient fields. The fields define an imaging slice through the subject and encode positions of materials of interest in the selected slice as a function of frequency. After imposition of radio frequency pulses, transverse moments are produced in gyromagnetic material of the subject through the slice, and echo signals from the material can be sensed and processed to identify the intensity of the response at the various locations in the slice. After data processing, an image can be reconstructed based upon the acquired and processed data.

Continuing with the example of an MRI system, various peripheral devices are typically used in the image acquisition, processing, reconstruction, and output of useful images. Depending upon the system design, various types and configurations of RF coils are used to excite the gyromagnetic material, and to capture response signals. In a broad sense, subsystems of the overall imaging system may be considered peripherals, including gradient coils, a primary magnet, a table or support on which a patient is positioned, functional push buttons, monitors and displays, input devices, and so forth. Each of these peripheral devices or subsystems are properly controlled to reliably produce the desired image data. Similar peripheral devices and subsystems are present in the other modality imaging equipment, particularly in x-ray systems, CT systems, ultrasound systems, and so forth.

Proper coordination of subsystems and peripheral devices in imaging systems is desirable for the capture, processing and display of desired images. In particular, many subsystems and peripheral devices are appropriately calibrated to account for device-to-device variances and tolerances, as well as for similar tolerances within individual devices. Moreover, where alternative devices are employed in a system, such as RF coils in an MRI system, the devices typically have different characteristics that should be taken into account during both the image data acquisition operation and during subsequent data processing.

Medical imaging systems, such as MRI systems, generally make use of high-speed and reliable communications with the various peripheral devices and subsystems. Unfortunately, existing systems use different communications protocols for the various peripheral devices and subsystems. The relatively large number of imaging subsystems and peripheral devices also complicates the present communications architecture, which has performance problems associated with the incompatibilities and limited communications capabilities. Existing imaging systems also fail to manage the peripheral devices and subsystems adequately to ensure that the devices are operational when needed for a desired imaging sequence. For example, if one or more peripheral devices are inoperable or non-communicative with the imaging system, then the imaging system may suffer considerable downtime or inaccurate results.

Accordingly, a technique is needed for more efficiently configuring, managing, and generally communicating with a wide variety of peripheral devices and imaging subsystems. More specifically, a uniform communications technique is needed to increase compatibility between the peripheral devices and imaging subsystems, to simplify architectural enhancements, to increase communications speed, and to increase the safety and reliability of the imaging system communications.

### SUMMARY OF INVENTION

The present technique provides a system and method for controlling, communicating with, and generally managing imaging subsystems and peripheral devices. The technique is applicable to a wide range of imaging systems, but is particularly well suited to complex imaging systems used in the medical diagnostics field. In the field of medical diagnostic imaging systems, the technique has particular promise for controlling, communicating with, and generally managing subsystems and devices in MRI systems, CT systems, x-ray systems, PET systems, and so forth. In a general sense, the technique facilitates more efficient and reliable communications with the subsystems and peripheral devices of the medical imaging system. For example, the present technique may use a CAN or CAN OPEN network architecture to provide uniform communications with the subsystems and peripheral devices and to provide a variety of operational checks to ensure the operational reliability of the imaging system.

In one aspect, the present technique provides a communications system for a medical imaging system. The system comprises a slave node for each of a plurality of components of the medical imaging system and a master node coupled to each slave node via a network. The system also has a uniform communications protocol for communications between the master node and each slave node.

In another aspect, the present technique provides a medical imaging system comprising a plurality of medical imaging components having network slave nodes. The medical imaging system also comprises control circuitry having a network master node for the network slave nodes. A uniform communications protocol is also provided for network communications between the network master node and the network slave nodes.

In another aspect, the present technique provides a method for communicating between components of a medical imaging system. The method comprises the act of managing the medical imaging system at a master node of a network having a slave node for each of a plurality of medical imaging components. The method also includes the act of communicating between the master and slave nodes using a uniform communications protocol.

In another aspect, the present technique provides a medical diagnostic system. The system comprises uniform communications means for communicating between components of the medical diagnostic system. The system also has message means for safely operating the medical diagnostic system.

In another aspect, the present technique provides a method for generating a medical diagnostic image. The method comprises the act of operating the medical imaging system at a master node of a network having a slave node for each of a plurality of medical imaging components. The method also comprises the act of communicating between the master and slave nodes using a uniform communications protocol. The method also includes the act of generating the medical diagnostic image.

In another aspect, the present technique provides a computer program for a medical diagnostic system. The computer program comprises a tangible medium configured to support machine-readable code and machine-readable code supported on the medium and comprising a network-based operational-management system for the medical diagnostic system. The network-based operational-management system comprises operational-management code and communications code. The operational-management code is adapted to manage the medical imaging system at a master node of a network having a slave node for each of a plurality of medical imaging components. The communications code is adapted to facilitate communications between the master and slave nodes using a uniform communications protocol.

### BRIEF DESCRIPTION OF DRAWINGS

The foregoing and other advantages and features of the invention will become apparent upon reading the following detailed description and upon reference to the drawings in which:

FIG. 1 is a diagrammatical representation of an exemplary imaging system in the form of an MRI system, including peripheral devices and subsystems capable, which are controllable and manageable according to various aspects of the present technique;

FIG. 2 is a diagrammatical representation of certain portions of the logical circuitry of the system of FIG. 1;

FIG. 3 is a graphical representation of an exemplary examination sequence that may be carried out in an imaging system such as that illustrated in FIG. 1;

FIG. 4 is a diagrammatical representation of an exemplary peripheral topology of the imaging system illustrated in FIG. 1;

FIG. 5 is a diagrammatical representation of the topology of various functional circuitry within a peripheral device equipped to store and access data;

FIG. 6 is a diagrammatical representation of an exemplary network having a master node and a plurality of slave nodes;

FIG. 7 is a diagrammatical representation of exemplary communications, safety, and management modules of the master and slave nodes;

FIG. 8 is a diagrammatical representation of an exemplary medical system network having a dual-conductor bus, a master node, and a plurality of slave nodes for components of the imaging system;

FIG. 9 is a flowchart illustrating an exemplary command-response system of the present technique;

FIG. 10 is a flowchart illustrating an exemplary message-response system of the present technique; and

FIG. 11 is an exemplary dual-conductor network having safety loopback wires between master and slave nodes.

### DETAILED DESCRIPTION

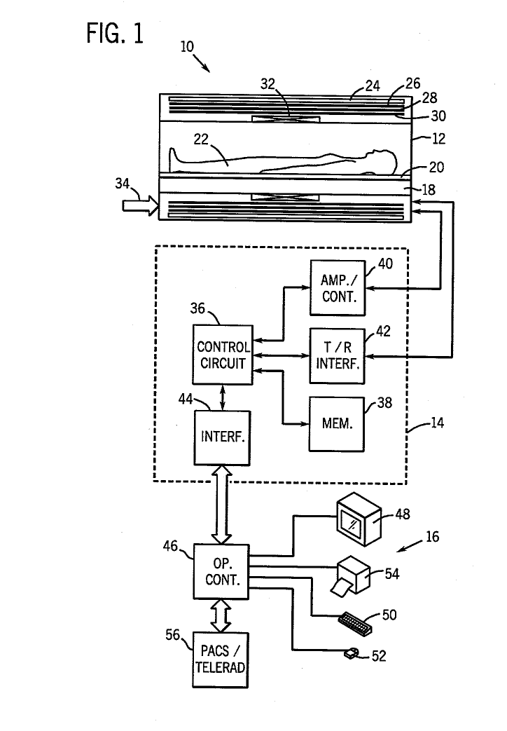

Turning now to the drawings, and referring to FIG. 1, an exemplary imaging system, in the form of a magnetic resonance imaging (MRI) system 10 is illustrated diagrammatically as including a data acquisition system 12, a control system 14, and an interface system 16. As discussed in further detail below, the imaging system 10 has a variety of components that are communicative and manageable over a relatively uniform-communications network architecture, such as a controller area network (CAN) or a CAN OPEN system configuration. For example, the imaging system 10, including subsystems 12, 14 and 16 and various other subsystems and peripheral devices, may be operated using CAN OPEN to increase communications speed and operational reliability. Although the imaging system 10 may include any suitable scanner or detector, in the illustrated embodiment, the system includes a full body scanner comprising a patient bore 18 into which a table 20 may be positioned to place a patient 22 in a desired orientation for scanning. Data acquisition system 12 may be of any suitable rating, including ratings varying from 0.2 Tesla to 1.5 Tesla, and beyond.

Data acquisition system 12 includes a series of associated coils for producing controlled magnetic fields, and for generating radio frequency excitation pulses, and for detecting emissions from gyromagnetic material within the patient in response to such pulses. In the diagrammatical view of FIG. 1, a primary magnet 24 is provided for generating a primary magnetic field, generally aligned with the patient bore. A series of gradient coils 26, 28 and 30 are grouped in a coil assembly for generating controlled magnetic gradient fields during examination sequences. A radio frequency coil 32 is provided for generating radio frequency pulses for exciting the gyromagnetic material. In the embodiment illustrated in FIG. 1, coil 32 also serves as a receiving coil. Thus, RF coil 32 may be coupled with driving and receiving circuitry in passive and active modes for receiving emissions from gyromagnetic material and for outputting radio frequency excitation pulses, respectively. Alternatively, various configurations of receiving coils may be provided separate from RF coil 32. Such coils may include structures specifically adapted for target anatomies, such as head coil assemblies, and so forth. Moreover, receiving coils may be provided in any suitable physical configuration, including phased array coils, and so forth.

As will be appreciated by those skilled in the art, in the case of the MRI system illustrated, when gyromagnetic material, typically bound in tissues of the patient, is subjected to the primary field, individual magnetic moments of the paramagnetic nuclei in the tissue attempt to align with the field but precess in a random order at their characteristic or Larmor frequency. While a net magnetic moment is produced in the direction of the polarizing field, the randomly oriented components of the moment in a perpendicular plane generally cancel one another. During an examination sequence, an RF excitation pulse is generated at or near the Larmor frequency of the material of interest, resulting in rotation of the net aligned moment to produce a net transverse magnetic moment. Radio signals are emitted following termination of the excitation signals. This magnetic resonance signal is detected in the scanner and processed for reconstruction of the desired image.

As a basis for the present discussion of management and control of peripheral devices and subsystems, a brief description of the operation of an MRI system is provided below. It should be borne in mind, however, that while the present technique is particularly well suited to MRI and similar medical diagnostic systems, it is not intended to be limited to any particular type, design, or modality system.

In the MRI system of FIG. 1, gradient coils 26, 28 and 30 serve to generate precisely controlled magnetic fields, the strength of which vary over a predefined field of view, typically with positive and negative polarity. When each coil is energized with known electric current, the resulting magnetic field gradient is superimposed over the primary field and produces a linear variation in the overall magnetic field strength across the field of view. Combinations of such fields, orthogonally disposed with respect to one another, enable the creation of a linear gradient in any direction by vector addition of the individual gradient fields.

The gradient fields may be considered to be oriented both in physical planes, as well as by logical axes. In the physical sense, the fields are mutually orthogonally oriented to form a coordinate system that can be rotated by appropriate manipulation of the pulsed current applied to the individual field coils. In a logical sense, the coordinate system defines gradients that are typically referred to as slice select gradients, frequency encoding gradients, and phase encoding gradients.

The slice select gradient determines a slab of tissue or anatomy to be imaged in the patient. The slice select gradient field may thus be applied simultaneous with a selective RF pulse to excite a known volume of spins within a desired slice that precess at the same frequency. The slice thickness is determined by the bandwidth of the RF pulse and the gradient strength across the field of view.

A second logical gradient axis, the frequency encoding gradient axis is also known as the readout gradient axis, and is applied in a direction perpendicular to the slice select gradient. In general, the frequency-encoding gradient is applied before and during the formation of the MR echo signal resulting from the RF excitation. Spins of the gyromagnetic material under the influence of this gradient are frequency encoded according to their spatial position across the gradient field. By Fourier transformation, acquired signals may be analyzed to identify their location in the selected slice by virtue of the frequency encoding.

Finally, the phase encode gradient is generally applied in a sequence before the readout gradient and after the slice select gradient. Localization of spins in the gyromagnetic material in the phase encode direction is accomplished by sequentially inducing variations in phase of the precessing protons of the material by using slightly different gradient amplitudes that are sequentially applied during the data acquisition sequence. Phase variations are thus linearly imposed across the field of view, and spatial position within the slice is encoded by the polarity and the degree of phase difference accumulated relative to a null position. The phase encode gradient permits phase differences to be created among the spins of the material in accordance with their position in the phase encode direction.

As will be appreciated by those skilled in the art, a great number of variations may be devised for pulse sequences employing the logical axes described above. Moreover, adaptations in the pulse sequences may be made to appropriately orient both the selected slice and the frequency and phase encoding to excite the desired material and to acquire resulting MR signals for processing.

The coils of system 12 are controlled by control system 14 to generate the desired magnetic field and radio frequency pulses. In the diagrammatical view of FIG. 1, control system 14 thus includes a control circuit 36 for commanding the pulse sequences employed during the examinations, and for processing received signals. Control circuit 36 may include any suitable programmable logic device, such as a CPU or digital signal processor of a general purpose or application-specific computer. Control circuit 36 further includes memory circuitry 38, such as volatile and nonvolatile memory devices for storing physical and logical axis configuration parameters, examination pulse sequence descriptions, acquired image data, programming routines, and so forth, used during the examination sequences implemented by the scanner.

Interface between the control circuit 36 and the gradient coils of data acquisition system 12 is managed by amplification and driver circuitry 40. RF coil 32 is similarly interfaced by transmission and receive interface circuitry 42. Circuitry 40 includes amplifiers for each gradient field coil to supply drive current to the field coils in response to control signals from control circuit 36. Interface circuitry 42 includes additional power amplification circuitry for driving RF coil 32. Moreover, where the RF coil serves both to emit the radio frequency excitation pulses and to receive MR signals, circuitry 42 will typically include a switching device for toggling the RF coil between active or transmitting mode, and passive or receiving mode. A power supply, denoted generally by reference numeral 34 in FIG. 1, is provided for energizing the primary magnet 24. Finally, circuitry 14 includes interface components 44 for exchanging configuration and image data with interface system 16.

Interface system 16 may include a wide range of devices for facilitating interface between an operator or radiologist and data acquisition system 12 via control system 14. In the illustrated embodiment, for example, an operator controller 46 is provided in the form of a computer workstation employing a general purpose or application-specific computer. The station also typically includes memory circuitry for storing examination pulse sequence descriptions, examination protocols, user and patient data, image data, both raw and processed, and so forth. The station may further include various interface and peripheral drivers for receiving and exchanging data with local and remote devices. In the illustrated embodiment, such devices include a conventional computer keyboard 50 and an alternative input device such as a mouse 52. A printer 54 is provided for generating hard copy output of documents and images reconstructed from the acquired data. A computer monitor 48 is provided for facilitating operator interface. In addition, system 10 may include various local and remote image access and examination control devices, represented generally by reference numeral 56 in FIG. 1. Such devices may include picture archiving and communication systems, teleradiology systems, and the like.

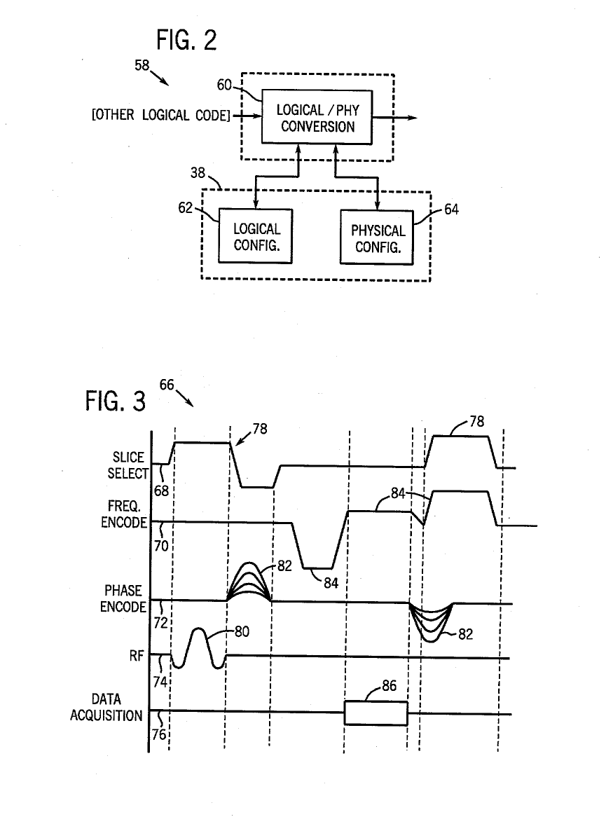

Depending upon the physics (i.e. the modality) of the imaging system 10, examinations will be performed to produce image data for reconstruction of a useful image. In the case of an MRI system, for example, these examinations include pulse sequences carried out by application of control signals to the gradient and RF coils, and by receiving resulting signals from the subject. In general, these pulse sequences will be defined by both logical and physical configuration sets and parameter settings stored within control system 14. FIG. 2 represents, diagrammatically, relationships between functional components of control circuit 36 and configuration components stored with memory circuitry 38. The functional components facilitate coordination of the pulse sequences to accommodate preestablished settings for both logical and physical axes of the system. In general, the axis control modules, denoted collectively by reference numeral 58, include a logical-to-physical module 60, which is typically implemented via software routines executed by control circuit 36. In particular, the conversion module is implemented through control routines that define particular pulse sequences in accordance with preestablished imaging protocols.

When called upon, code defining the conversion module references logical configuration sets 62 and physical configuration sets 64. The logical configuration sets may include parameters such as pulse amplitudes, beginning times, time delays, and so forth, for the various logical axes described above. The physical configuration sets, on the other hand, will typically include parameters related to the physical constraints of the scanner itself, including maximum and minimum allowable currents, switching times, amplification, scaling, and so forth. Conversion module 60 serves to generate the pulse sequence for driving the coils of scanner 12 in accordance with constraints defined in these configuration sets. The conversion module will also serve to define adapted pulses for each physical axis to properly orient (e.g. rotate) slices and to encode gyromagnetic material in accordance with desired rotation or reorientations of the physical axes of the image.

By way of example, FIG. 3 illustrates a typical pulse sequence, which may be implemented on a system such as that illustrated in FIG. 1 and calling upon configuration and conversion components such as those shown in FIG. 2. While many different pulse sequence definitions may be implemented, depending upon the examination type, in the example of FIG. 3, a gradient recalled acquisition in steady state mode (GRASS) pulse sequence is defined by a series of pulses and gradients appropriately timed with respect to one another. The pulse sequence, indicated generally by reference numeral 66, is thus defined by pulses on a logical slice select axis 68, a frequency-encoding axis 70, a phase encoding axis 72, an RF axis 74, and a data acquisition axis 76. In general, the pulse sequence description begins with a pair of gradient pulses on slice select axis 68 as represented at reference numeral 78. During a first of these gradient pulses, an RF pulse 80 is generated to excite gyromagnetic material in the subject. Phase encoding pulses 82 are then generated, followed by a frequency encoding gradient 84. A data acquisition window 86 provides for sensing signals resulting from the excitation pulses, which are phase and frequency encoded. The pulse sequence description terminates with additional gradient pulses on the slice select, frequency encoding, and phase encoding axes.

As will be appreciated by those skilled in the art, the foregoing operation of an MRI system, and other procedures for obtaining image data on other modality imaging systems calls for a number of peripheral devices and subsystems operating in concert. For example, in the foregoing example, the pulse sequence description is typically stored within the control system 14, and carried out upon request. However, various pulse sequences may call for different peripheral devices, such as RF coils 32. In a typical application, a clinician or radiologist will select an examination via interface system 16, and insert the appropriate RF coil in the data acquisition system 12. Similarly, the table on which the patient is positioned will be placed in the appropriate orientation, and the gradient coils will be prepared for the examination sequence. Well before these procedures are carried out, calibration procedures are performed on all of these peripheral devices, as well as on other components of the system. When the operator selects the examination sequence, an identification of the peripheral devices associated with the system, such as RF coil 32, is input through the interface system 16. The calibration information for the coil, as well as other relevant information is, in these prior art techniques, accessed from a storage device, typically the memory circuitry 38 of the imaging system itself.

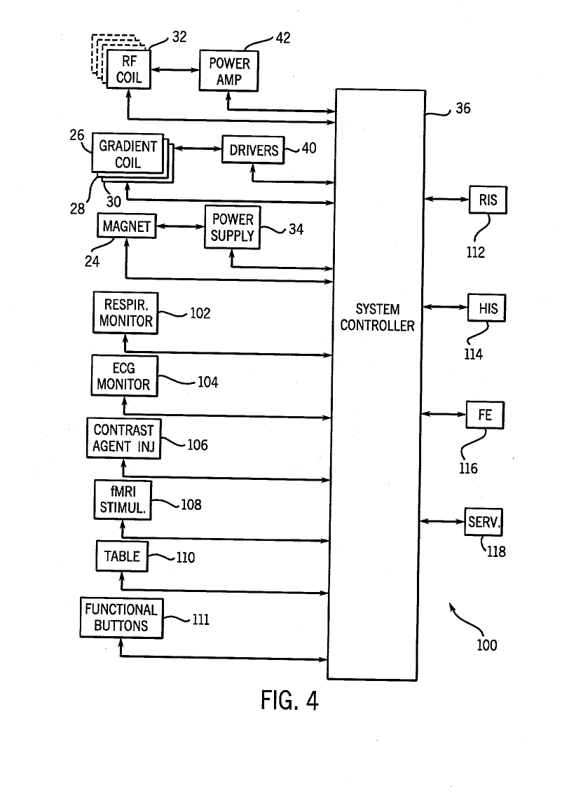

As mentioned above, the present technique facilitates the foregoing calibrations, operations, communications, and general management of peripheral devices by organizing the imaging system with a uniform-communications network architecture, such as can or CAN Open. For example, the present technique may use the CAN OPEN architecture to increase communications speed and efficiency, to monitor for operational problems or errors, and to generally improve reliability and safety of the overall imaging system 10. FIG. 4 illustrates an exemplary peripheral topology 100 available through the present technique. As illustrated diagrammatically in FIG. 4, a wide variety of the peripherals and subsystems of the imaging system may include circuitry for storing and communicating identification data, calibration data, operational data, and other useful information and functional code.

In the embodiment illustrated in FIG. 4, each of these devices, illustrated on the left of system controller 36, can receive and transmit data in digital form through system controller 36 for use in examination sequences and servicing. For example, the system controller 36 may transmit a variety of operational commands, access requests, data requests, or other communications to one or more of these peripherals during calibration, downtime, operation, or any other time. The present technique improves these communications and management functions by unifying the communication protocols, adding reliability checks, streamlining the communications, and performing a variety of other performance and safety operations, as discussed below.

The peripherals and subsystems may include a variety of manageable or communicable components, such as conventional computer peripherals and imaging subsystems. For example, the components illustrated in FIG. 4 include the RF coils 32 and power amplification circuitry 42 for driving the coils. Each individual coil may include circuitry for storage and communication of data, as may the power amplification circuitry. Other such peripheral devices and subsystems may include gradient coils 26, 28 and 30, as well as driver circuitry 40 for controlling the fields produced by the gradient coils. Magnet 24, as well as its power supply 34, may be similarly equipped. In MRI systems, as well as in other medical diagnostic imaging equipment, similar peripheral devices may further include respiration monitors 102, ECG monitors 104, functional command buttons, and contrast agent injection devices 106. In the case of MRI systems, stimulating devices for functional MRI (fMRI) examinations may be equipped for storing, communicating, and generally managing data, as indicated at reference numeral 108. Finally, additional components of the system may be equipped with circuitry for performing similar management and communication functions. For example, the table 20 may have circuitry 110 for managing the table and a variety of functional buttons 111 may be disposed throughout the imaging system. The foregoing peripherals are all manageable over a network having a uniform communications protocol and various safety/monitoring messages and operations, as described in further detail below.

The particular configuration, management, and operation of the various peripheral devices may vary widely depending upon the nature of the peripheral device and its use in the system. Moreover, the system controller 36 may communicate a variety of operational data and commands with the various peripheral devices, including status checks and other reliability messages. For example, in the case of gradient coils and RF coils of an MRI system, data may be stored in each device to provide an indication of the peripheral type, its identification, the manufacturing date and source, and field strength. Calibration information resulting from separate calibration sequences may also be stored in the devices. Finally, service histories, including references or code indicative of particular services performed on the devices or problems encountered in the devices in the past may be similarly stored directly on the device. Other devices may have unique information associated with them that may be stored similarly. For example, the circuitry 110 associated with the table for positioning a patient in an MRI system may include data indicative of table weight limitations, which the system 10 accesses and uses during diagnostic imaging sequences. The information may serve as a basis, for example, in notifications or alarms output to clinicians when the table approaches or exceeds its weight limits.

In addition to storing and accessing informational data, each peripheral device or subsystem may further include executable code that may be carried out in coordination with system controller 36, or other external circuitry. For example, calibration algorithms, autocalibration procedures, and so forth, may be stored in peripheral devices requiring such calibration for examination sequences. These programs may be self executing upon connection of the devices to the system, as described below, or may be accessed and executed upon an operator prompt or upon a call sequence from a routine executed by the external components.

The peripheral devices and subsystems illustrated in FIG. 4, as well as other peripheral devices that may be added or useful in the system, preferably communicate through system controller 36. As noted above, system controller may store information on each device, transmit commands or information to each device, and communicate with each device as desired for particular imaging needs. Moreover, system controller 36 may act as an interface for communicating certain commands, requests, safety checks, or other information to a variety of systems both within an institution and outside the institution. As illustrated in FIG. 4, for example, a radiology department informational system 112 may be coupled to system controller, such as via an intranet or the like, to communicate with the peripheral devices and subsystems and to perform management operations with each device as desired. Similar communications and management functions may be performed with a hospital information system, as indicated at reference numeral 114. A field engineer station 116 may similarly communicate with the peripheral devices and subsystems through system controller 36. For example, a field engineer laptop may be coupled to a system controller for accessing device data, monitoring the device, or otherwise managing the device. Finally, in the embodiment illustrated in FIG. 4, a remote servicing facility 118 may communicate with system controller to manage and generally communicate with the peripheral devices and subsystems. The service facility accessing the imaging system 10 in this manner may be entirely remote from the imaging system or institution, such as in a remote service center connected to the institution via an open wide area network, such as the Internet, a virtual proprietary network or the like.

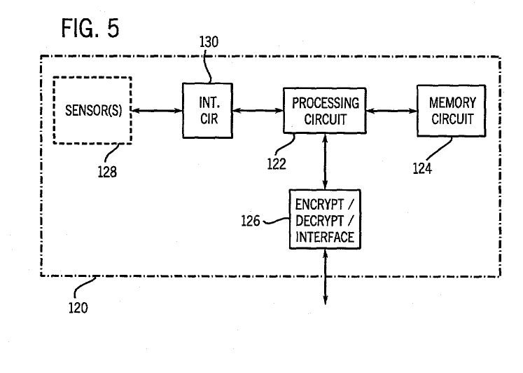

The present technique is applicable to a variety of system components (e.g., peripherals and subsystems), which may have various configurations for the storage and communication of data and code (e.g., operational commands). FIG. 5 illustrates an exemplary peripheral topology 120 in accordance with a present embodiment. In this topology, a processing circuit 122 is provided for executing any functional code, exchanging data, responding to data requests and commands, and so forth. Processing circuit 122, which may typically include a programmed microprocessor, draws data from a memory circuit 124 where the data is stored. The memory circuit may include any suitable type of memory, but preferably includes non-volatile memory capable of retaining the data when power is removed from the peripheral device or subsystem. Processing circuit 122 may also write data to the memory circuit, such as upon initial manufacturing and testing of the device, following calibration sequences, following service events, and so forth. Where the peripheral device or subsystem includes sensors 128, these also form part of the preferred topology. Such sensors may be provided, for example, for detecting temperatures of coils, acoustical signals for cardiac monitors, flow rates for contrast agent injection devices, force or a related parameter for table weight monitoring, and so forth. Where required, interface circuitry 130 is provided for conditioning signals received from the sensors 128 before application of the signals to processing circuitry 122. It should be noted that in addition to the exchange of data in the topology of FIG. 5, power may be transmitted between the devices such as for powering processing circuit 122 and sensors 128.

Where desired, interface circuitry 126 may be provided in each device for encrypting and decrypting data and communications, such as operational commands and reliability checks. As will be appreciated by those skilled in the art, such circuitry will generally translate data between encrypted and decrypted forms to limit access or the utility of the data to external circuits. Interface 126 may further include circuitry for verification of the identity of a requesting circuit as described below. Such identification is particularly useful in limiting access of the stored data by external circuitry, devices, and personnel.

The topology provided in the embodiment of FIG. 5 may be based upon any suitable programming code and architecture. For example, a product family available from Dallas Semiconductor of Dallas, Tex., under the commercial designation Crypto iButton, may serve as the platform for the topology. Such devices maybe installed in a quick disconnect box for a variety of RF coils of an MRI system. The devices are then programmed to contain manufacturing and calibration data specific to each coil, as well as a dynamically updated record of the total number of uses of the coil. In operation, as each RF coil is coupled to a standard coil receptacle, the coil is automatically identified by the imaging system interface and the interface is updated to reflect insertion of the coil, including an electronic image of the coil itself, provided on a monitor (see monitor 48 in FIG. 1). The system is made back-compatible for coils not equipped with the preferred data topology by prompting the user to select a coil from a list of candidate coils if the coil is not identified during the initial connection sequence. The device includes a single-chip trusted microcomputer as processing circuit 122, equipped with a Java virtual machine, a 1024-bit math accelerator, and an unalterable real time clock. Memory circuit 124 includes a 6 K-byte random access memory and a 32 K-byte read-only memory. The processing functions include RSA encryption.

More limited topographies are, of course, available in the present technique. For example, where no processing capabilities are required, or very limited capabilities are required, specific analog or digital circuitry may be provided in the topology for this purpose. Moreover, memory-only devices may be provided in which data is merely stored and accessed.

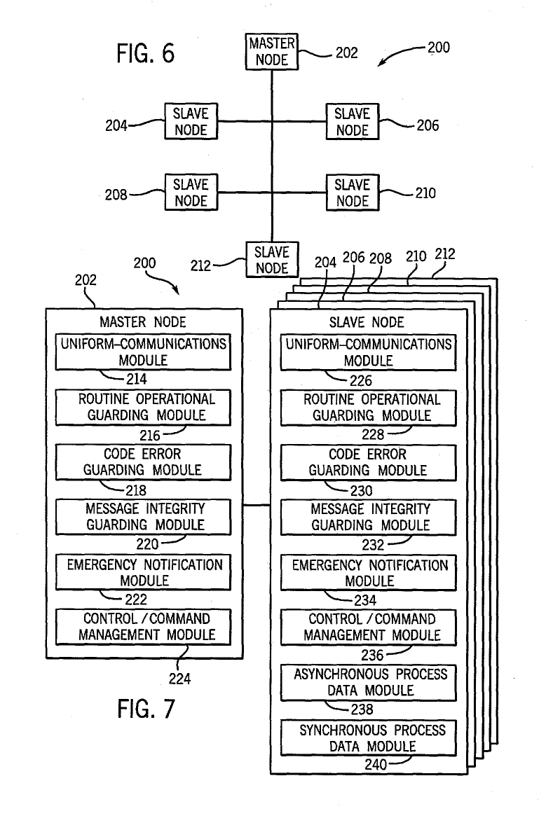

FIG. 6 is a diagram illustrating an exemplary network 200 for the imaging system 10 of the present technique. As illustrated, the network 200 has a master node 202 and a plurality of slave nodes, such as slave nodes 204-212. The master node 202 may be disposed in any suitable location within the imaging system 10, while each slave node corresponds to a specific subsystem or peripheral device, such as illustrated by FIG. 4. For example, the master node 202 may be disposed in the data acquisition system 12, in the control system 14, or in the interface system 16. The master node 202 also may be disposed in a remote system, such as a remote computing device, a remote medical facility, a remote servicing center, or any other desired remote location. The use of master and slave nodes make the system flexible and expandable, while the uniform communications protocol improves compatibility between subsystems and peripherals and improves system response times.

The master node 202 is responsible for stimulating the slave nodes 204-212. For example, the master node 202 may command one or more of the slave nodes to start/stop operation, to perform a status check, to return a response or data, to verify receipt or completion of a command/message, or to perform any other operation at a desired time. In this exemplary embodiment, the master node 202 monitors and senses faults in the imaging system 10 by monitoring and interacting with each individual slave node. The master node 202 may perform these operations periodically, randomly, upon request by a user, upon occurrence of a system event (e.g., a fault, an operation, etc.), or at any other desired time.

The slave nodes are responsible for providing the master node 202 with data, which may be synchronously or asynchronously required by the master node 202. The function of the component (e.g., peripheral device or subsystem) disposed at the particular slave node determines the nature and timing of the required data. Although the exact operation of each slave node may be unique, the slave nodes 204-212 all conform to the same protocol specification and connect to the same physical bus of the network 200.

In this exemplary embodiment, the network 200 is a Controller Area Network (CAN), which uses a uniform communications protocol to communicate between the master and slave nodes. For example, the network 200 may use a CAN bus and a CAN Open protocol to create a high-speed communications physical layer running at speeds up to 1 Mbits/second. The CAN Open protocol is utilized as an application layer to allow for architectural enhancements, increased safety and reliability, and efficient communications methodology. The can scheme also implements a variety of safety measures, which make the system 10 more reliable than previous serial communications.

FIG. 7 is a diagram illustrating exemplary components of the master and slave nodes described above. As illustrated, the master and slave nodes have a variety of communications, guarding, messaging, and command management modules to increase safety and efficiency of the imaging system 10 disposed on the network 200. For example, the master node 202 may comprise a uniform communications module 214, a routine operational guarding module 216, a code error guarding module 218, a message integrity guarding module 220, an emergency notification module 222, and a control/command management module 224. Similarly, one or more of the slave nodes 204-212 may comprise a uniform communications module 226, a routine operational guarding module 228, a code error guarding module 230, a message integrity guarding module 232, an emergency notification module 234, a control/command management module 236, an asynchronous process data module 238, and a synchronous process data module 240. The foregoing modules 214-240 may comprise a variety of hardware and software, which may be integral or add-on components of the imaging system 10 and its components (e.g., subsystems and peripherals).

The uniform communications modules 214 and 226 may be any suitable communications circuitry and routines, which use a uniform communications protocol for intercommunications between the master and slave nodes. For example, as mentioned above, the network 200 may use a CAN Open communications protocol.

The routine operational guarding modules 216 and 228 interact with one another to monitor the operational status and generally manage devices at each slave node. For example, module 216 at the master node 202 may transmit a node-guarding message to each slave node on a periodic basis requiring an immediate response with a toggled-bit. The slave node's failure to respond to any of these messages will force the master node 202 to place the slave node into a predetermined safe state and inform the host (e.g., host application, user interface, etc.) of the slave node's failure to respond. Similarly, each slave node will expect to receive the node-guarding message from the master node 202 on a periodic basis. If the slave node does not receive the node-guarding message, then the slave node will place itself into the safe state and inform the master node 202 of the problem. The routine operational guarding modules 216 and 228 also may perform a variety of other monitoring, status checking, and node maintenance operations to minimize downtime of the devices at each node and to minimize overall system downtime. The present technique may use the foregoing message-response procedure for transmissions between any of the master and slave nodes. Accordingly, these modules 216 and 228 improve the reliability of the imaging system 10.

The code error guarding modules 218 and 230, or CPU-watchdogs, monitor the imaging system 10 and protect the various master and slave nodes against firmware or other software errors. For example, the modules 218 and 230 may perform a periodic operation, or a periodic data write, to ensure that no code errors result in the operation of the device.

The message integrity guarding modules 220 and 232 perform operations on each data transmission being sent and received between the master and slave nodes to ensure the data integrity on the network 200. For example, the modules 220 and 232 may perform automatic cyclic redundancy checks (CRC), such as polynomial operations, on each message or data transmission. If the foregoing operation yields matching results at both ends of the communication, then the modules 220 and 232 validate the data transmission. The message integrity guarding modules 220 and 232 also may perform a variety of other message integrity checks within the scope of the present technique.

The emergency notification modules 222 and 234 are provided to facilitate an immediate notification of device faults or safety issues, which have been detected on the master or slave nodes. For example, if one of the slave nodes detects a problem or safety issue, then that slave node may immediately inform the master node 202 of the detected problem. The master node 202, or the user, may then evaluate the problem and initiate corrective procedures, such as placing the slave node into a safe state or performing further analysis.

The control/command management modules 224 and 236 ensure the receipt and execution of commands transmitted between the master and slave nodes. For example, the modules 224 and 236 may perform a command-response procedure similar to the message-response procedure described above with reference to the routine operational guarding modules 216 and 228. If the master node 202 transmits a command to one of the slave nodes, then the intended slave node must receive or execute the command within a specified time. If the intended slave node does not receive and/or execute the command within the specified time, then the master or slave node may place the intended slave node into an alternate mode, such as a safe state. The present technique may use the foregoing command-response procedure for transmissions between any of the master and slave nodes. Accordingly, these modules 224 and 236 improve the reliability of the imaging system 10.

The master and slave nodes also may have variety of other monitoring modules, status checking modules, transmission-reply check modules, message authentication modules, device analysis and correction modules, and redundant safety-insurance modules to improve the reliability of the imaging system 10. For example, one or more of the slave nodes may have asynchronous and synchronous process data modules 238 and 240, which facilitate periodic and request-driven data communications between the master and slave nodes. The asynchronous process data module 238 may be used to transfer data periodically, or event-driven, from the slave node to the master node 202 without the master node 202 querying for the data. This request-independent operation saves network overhead, and improves communications efficiency of the network 200. The synchronous process data module 240 may be used to transfer data from the slave node to the master node 202 in response to the master node 202 querying for the data.

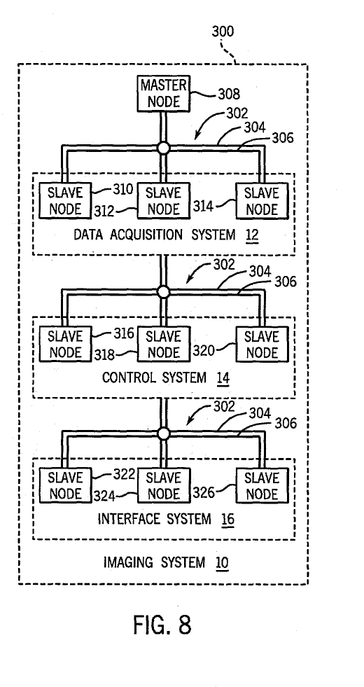

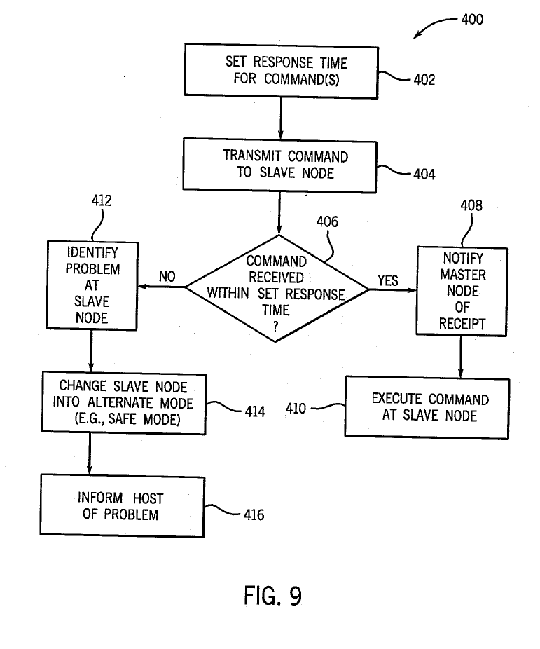

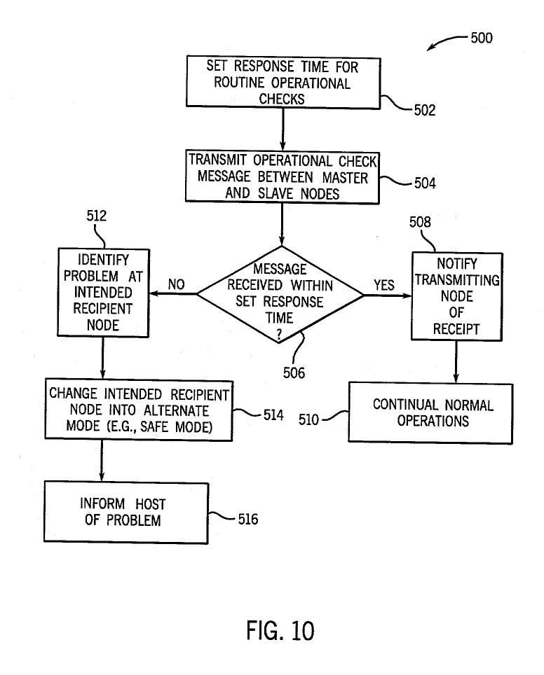

The techniques described above with reference to FIGS. 6 and 7 are applicable to a wide variety of medical diagnostic and imaging systems, including various networks of medical equipment at one or more sites and for one or more medical modalities. FIG. 8 is a diagram illustrating an exemplary medical system network 300 for the imaging system 10 illustrated by FIG. 1. As illustrated, the medical system network 300 communicatively couples various components (e.g., subsystems or peripherals) of the imaging system 10 via a dual-conductor assembly 302, which may comprise a CAN high conductor 304 and a CAN low conductor 306. Although not illustrated, the various components may be coupled in series, in parallel, or in a combination of series and parallel connections. In the illustrated embodiment, the medical system network 300 has a master node 308 and a plurality of slave nodes, such as slave nodes 310-326, which are distributed throughout the imaging system 10 at components within subsystems 12, 14, and 16. For example, the data acquisition system 12 has slave nodes 310, 312, and 314, the control system 14 has slave nodes 316, 318, and 320, and the interface system 16 has slave nodes 322, 324, and 326. These slave nodes 310-326 may represent any desired medical components, peripherals, or subsystems, such as the components illustrated by FIGS. 1 and 4.

As discussed above, the present technique may utilize a variety of communications, monitoring, and operational maintenance modules to improve the reliability and efficiency of the imaging system 10. FIG. 8 is a flowchart illustrating an exemplary command-response system 400 of the present technique. The system 400 may comprise the control/command management modules 224 and 236, as illustrated by FIG. 7, or any other suitable software and circuitry. In this exemplary embodiment, the command-response system 400 proceeds by setting a response time for commands (block 402). For example, a response time of X1 ms may be required for commands sent to one slave node, while a response time of X2 ms may be required for commands sent to another slave node. In operation, the system 400 transmits a command to one or more slave nodes for execution at the respective slave node (block 404). The system 400 then queries whether the intended slave node received the command within the set response time (block 406).

If the intended slave node receives the transmitted command, then the system 400 proceeds to notify the master node of its receipt (block 408). The system 400 then proceeds to execute the command at the slave node (block 410). The system 400 also may notify the master node of the slave node's execution of the command. In contrast, if the intended slave node does not receive the transmitted command, then the system 400 proceeds to identify the problem at the slave node (block 412). For example, the system 400 may identify a communications error, a device error, or any other such error. The system 400 then proceeds to change the slave node into an alternate mode, such as a safe mode (block 414). The command-receipt system 400 then informs the host of the identified problem (block 416). For example, the system 400 may inform the host medical imaging system 10, the user, or any other desired device or application of the identified problem. Accordingly, the system 400 identifies problems, informs the user or application, improves safety associated with faulty devices or poor communications, and facilitates correction of the identified problems.

FIG. 8 is a flowchart illustrating an exemplary message-response system 500 of the present technique. The system 500 may comprise the routine operational guarding modules 216 and 228, as illustrated by FIG. 7, or any other suitable software and circuitry. In this exemplary embodiment, the message-response system 500 proceeds by setting a response time for routine operational check messages (block 502). For example, a response time of Y1 ms may be required for operational check messages sent to one slave node, while a response time of Y2 ms may be required for operational check messages sent to another slave node. In operation, the system 500 transmits an operational check message, or any other desired message, between master and slave nodes (block 504). The system 500 then queries whether the intended recipient (e.g., slave node) received the message within the set response time (block 506). The system 500 may transmit these messages in either direction between the master and slave nodes, thereby allowing status checks of both master and slave nodes.

If the intended recipient receives the transmitted message, then the system 500 proceeds to notify the transmitting node of its receipt (block 508). The system 500 then proceeds with normal operations (block 510). In contrast, if the intended recipient node does not receive the transmitted message, then the system 500 proceeds to identify the problem at the intended recipient node (block 512). For example, the system 500 may identify a communications error, a device error, or any other such error. The system 500 then proceeds to change the intended recipient node into an alternate mode, such as a safe mode (block 514). The command-receipt system 500 then proceeds to inform the host of the identified problem (block 516). For example, the system 500 may inform the host medical imaging system 10, the user, or any other desired device or application. Accordingly, the system 500 performs these periodic message-response operations to identify problems, inform the user or application of such problems, improve safety associated with faulty devices or poor communications, and facilitate correction of the identified problems.

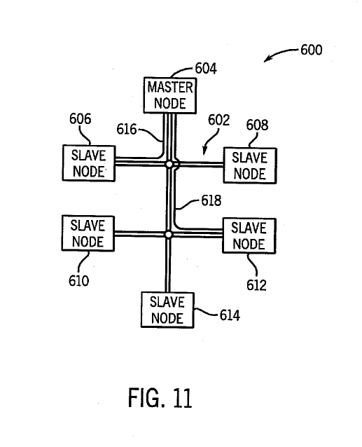

The present technique also may provide a hard-wire for one or more of the slave nodes, such as system critical slave nodes. FIG. 11 is a diagram illustrating an exemplary dual-conductor network 600 having dual-conductor linkages 602 (e.g., high and low CAN linkages) between a master node 604 and a plurality of slave nodes, such as slave nodes 606-614. As illustrated, a hard-wire linkage 616 extends between the master node 604 and the slave node 606 and a hard-wire linkage 618 extends between the master node 604 and the slave node 612. Similar hard-wire linkages, or a single hard wire linkage, may extend between the master node 604 and all of the slave nodes 606-614. In operation, these hard-wire linkages, or safety loopback wires, may be used for critical messages, commands, or in situations where one or more system component is not operating properly. For example, the network 600 may toggle the signal to one of the hard-wire linkages for immediately notifying the master node 604 of a communications or device error.

As discussed above, the foregoing techniques may be performed using a uniform-communications network architecture, such as CAN or CAN Open. The CAN architecture facilitates a relatively safe and efficient operation of the medical imaging system 10 as compared to conventional networks used in the medical field. The features described above, and various other CAN safety features, provide redundancy that decreases downtime and improves performance of the system 10. The present technique also relieves the master node from the operation of polling the slave nodes for data that is required periodically. As described above, asynchronous process data modules are used to reduce the protocol overhead of the imaging system 10 and to meet the high-speed demands of medical imaging systems. For example, the asynchronous process data modules quickly transmit critical data and messages, such as safety problems in the various components of the medical imaging system 10. The assignment of response times for messages transmitted between nodes, such as asynchronous and synchronous commands or status check messages, also improves the performance and predictability of the imaging system 10. Moreover, the network organization of the imaging system 10 into a plurality of slave nodes facilitates flexible management of the various components of the system 10. For example, if an error is detected at a particular slave node, then master node is able to shut down that specific slave node without disturbing the integrity of the remaining slave nodes of the imaging system 10.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A communications system for a medical imaging system, comprising:
a slave node for each of a plurality of components of the medical imaging system;
a master node coupled to each slave node via a network;
a uniform communications protocol for communications between the master node and each slave node.

2. The communications system of claim 1, wherein the network comprises a controller area network bus.

3. The communications system of claim 2, wherein the network comprises controller area network high and low communications links.

4. The communications system of claim 1, wherein the network comprises a safety loopback communications link.

5. The communications system of claim 1, wherein the uniform communications protocol comprises a controller area network open protocol.

6. The communications system of claim 1, wherein the plurality of components comprise image acquisition components of the medical imaging system.

7. The communications system of claim 1, wherein the plurality of components comprise image processing components of the medical imaging system.

8. The communications system of claim 1, wherein the plurality of components comprise user interaction components of the medical imaging system.

9. The communications system of claim 1, wherein the plurality of components comprise monitoring components of the medical imaging system.

10. The communications system of claim 1, wherein the master node is disposed on control circuitry.

11. The communications system of claim 1, wherein the master node comprises a fault sensing system to identify component faults at the slave nodes.

12. The communications system of claim 11, wherein the fault sensing system comprises a message-response system having a critical response time.

13. The communications system of claim 12, wherein the message-response system comprises a periodic monitoring message, which comprises a response request.

14. The communications system of claim 11, wherein the fault sensing system comprises a safe mode backup system for the plurality of components.

15. The communications system of claim 1, wherein the master node comprises a component control system having a timed-component-response system.

16. The communications system of claim 1, wherein at least one of the slave nodes comprises an emergency status messaging module.

17. The communications system of claim 1, wherein at least one of the slave nodes comprises an asynchronous data communications module adapted to transfer data periodically from the slave node to the master node without the master node querying for the data.

18. The communications system of claim 1, wherein at least one of the slave nodes comprises a synchronous data communications module adapted to transfer data from the slave node to the master node in response to the master node querying for the data.

19. The communications system of claim 1, wherein at least one of the slave nodes comprises a fault sensing system to identify component faults at the slave node.

20. The communications system of claim 1, wherein the uniform communications protocol comprises a cyclic redundancy check module adapted to ensure data integrity on the network.

21. A medical imaging system, comprising:
a plurality of medical imaging components having network slave nodes;
control circuitry having a network master node for the network slave nodes; and
a uniform communications protocol for network communications between the network master node and the network slave nodes.

22. The medical imaging system of claim 21, wherein the network master node and the network slave nodes are communicatively coupled via a controller area network.

23. The medical imaging system of claim 22, wherein the controller area network comprises high and low communications links.

24. The medical imaging system of claim 22, wherein the network comprises a safety loopback communications link extending between the control circuitry and the plurality of medical imaging components.

25. The medical imaging system of claim 21, wherein the uniform communications protocol comprises a controller area network open protocol.

26. The medical imaging system of claim 21, wherein the uniform communications protocol comprises an event-driven communications module.

27. The medical imaging system of claim 26, wherein the event-driven communications module comprises a component status notification system.

28. The medical imaging system of claim 21, wherein the uniform communications protocol comprises a periodic communications module.

29. The medical imaging system of claim 28, wherein the periodic communications module comprises a message-response monitoring system.

30. The medical imaging system of claim 21, wherein the network master node comprises a fault sensing system to identify component faults at the network slave nodes.

31. The medical imaging system of claim 21, wherein the network master node comprises a component control system having a timed-component-response system.

32. The medical imaging system of claim 21, wherein at least one of the network slave nodes comprises an emergency status notification module.

33. The medical imaging system of claim 21, wherein at least one of the network slave nodes comprises an asynchronous data communications module adapted to transfer data periodically from the network slave node to the network master node without the network master node querying for the data.

34. The medical imaging system of claim 21, wherein at least one of the network slave nodes comprises a synchronous data communications module adapted to transfer data from the network slave node to the network master node in response to the network master node querying for the data.

35. The medical imaging system of claim 21, wherein the uniform communications protocol comprises a cyclic redundancy check module adapted to ensure data integrity on the network.

36. A method for communicating between components of a medical imaging system, comprising the acts of:
managing the medical imaging system at a master node of a network having a slave node for each of a plurality of medical imaging components; and
communicating between the master and slave nodes using a uniform communications protocol.

37. The method of claim 36, wherein the act of managing the medical imaging system comprises the act of operating the medical imaging system.

38. The method of claim 36, wherein the act of managing the medical imaging system comprises the act of monitoring operational characteristics of the plurality of medical imaging components.

39. The method of claim 36, wherein the act of managing the medical imaging system comprises the act of efficiently controlling the plurality of medical imaging components using the uniform communications protocol.

40. The method of claim 36, wherein the act of communicating comprises the act of providing communications compatibility among the plurality of medical imaging components.

41. The method of claim 36, wherein the act of communicating comprises the act of transmitting messages over a controller area network bus.

42. The method of claim 36, wherein the act of communicating comprises the act of networking the master and slave nodes with a controller area network open protocol.

43. The method of claim 36, wherein the act of communicating comprises the act of transmitting data over at least one of high and low communications links.

44. The method of claim 36, wherein the act of communicating comprises the act of transmitting an event-driven message.

45. The method of claim 44, wherein the act of transmitting the event-driven message comprises the act of notifying the master node of a component status at one of the slave nodes.

46. The method of claim 44, wherein the act of transmitting the event-driven message comprises the act of notifying the master node of a component fault at one of the slave nodes.

47. The method of claim 36, wherein the act of communicating comprises the act of transmitting a periodic status message.

48. The method of claim 47, wherein the act of transmitting the periodic status message comprises the act of sending a timed-response request to at least one of the slave nodes.

49. The method of claim 48, wherein the act of transmitting the periodic status message comprises the act of changing the slave node to a safe state if the slave node does not respond to the timed-response request as requested.

50. The method of claim 47, wherein the act of transmitting the periodic status message comprises the act of notifying the master node of an error if the slave node does not receive the periodic status message from the master node.

51. The method of claim 36, wherein the act of managing comprises the acts of:
sending a command to one of the slave nodes; and
requesting a command verification from the slave node.

52. The method of claim 51, wherein the act of requesting the command verification comprises the act of setting a maximum response time for the slave node to respond to the requested command verification.

53. A medical diagnostic system, comprising:
uniform communications means for communicating between components of the medical diagnostic system; and
message means for safely operating the medical diagnostic system.

54. The medical diagnostic system of claim 53, comprising image acquisition means for the medical diagnostic system.

55. The medical diagnostic system of claim 53, comprising user interaction means for the medical diagnostic system.

56. A method for generating a medical diagnostic image, comprising the acts of:
operating the medical imaging system at a master node of a network having a slave node for each of a plurality of medical imaging components;
communicating between the master and slave nodes using a uniform communications protocol; and
generating the medical diagnostic image.

57. The method of claim 56, wherein the act of operating the medical imaging system comprises the act of monitoring operational characteristics of the plurality of medical imaging components.

58. The method of claim 56, wherein the act of operating the medical imaging system comprises the act of efficiently controlling the plurality of medical imaging components using the uniform communications protocol.

59. The method of claim 56, wherein the act of communicating comprises the act of providing communications compatibility among the plurality of medical imaging components.

60. The method of claim 56, wherein the act of communicating comprises the act of transmitting messages over a controller area network bus.

61. The method of claim 56, wherein the act of communicating comprises the act of networking the master and slave nodes with a controller area network open protocol.

62. The method of claim 56, wherein the act of communicating comprises the act of transmitting data over at least one of high and low communications links.

63. The method of claim 57, wherein the act of communicating comprises the act of transmitting an event-driven message.

64. The method of claim 63, wherein the act of transmitting the event-driven message comprises the act of notifying the master node of a component status at one of the slave nodes.

65. The method of claim 63, wherein the act of transmitting the event-driven message comprises the act of notifying the master node of a component fault at one of the slave nodes.

66. The method of claim 56, wherein the act of communicating comprises the act of transmitting a periodic status message.

67. The method of claim 66, wherein the act of transmitting the periodic status message comprises the act of sending a timed-response request to at least one of the slave nodes.

68. The method of claim 67, wherein the act of transmitting the periodic status message comprises the act of changing the slave node to a safe state if the slave node does not respond to the timed-response request as requested.

69. The method of claim 66, wherein the act of transmitting the periodic status message comprises the act of notifying the master node of an error if the slave node does not receive the periodic status message from the master node.

70. The method of claim 56, wherein the act of operating comprises the acts of:
sending a command to one of the slave nodes; and
requesting a command verification from the slave node.

71. The method of claim 70, wherein the act of requesting the command verification comprises the act of setting a maximum response time for the slave node to respond to the requested command verification.

72. A computer program for a medical diagnostic system, comprising:
a tangible medium configured to support machine-readable code; and
machine-readable code supported on the medium and comprising a network-based operational-management system for the medical diagnostic system, the network-based operational-management system comprising:
operational-management code adapted to manage the medical imaging system at a master node of a network having a slave node for each of a plurality of medical imaging components; and
communications code adapted to facilitate communications between the master and slave nodes using a uniform communications protocol.

73. The computer program of claim 72, wherein the operational-management code comprises component monitoring code adapted to monitor operational characteristics of the plurality of medical imaging components.

74. The computer program of claim 72, wherein operational-management code and the communications code comprise controller area network code.

75. The computer program of claim 72, wherein operational-management code and the communications code comprise controller area network open code.

76. The computer program of claim 72, wherein the machine-readable code comprises event-driven communications code.

77. The computer program of claim 76, wherein the even-driven communications code comprises status notification code adapted to notify the master node of a component status at one of the slave nodes.

78. The computer program of claim 77, wherein status notification code comprises fault notification code adapted to notify the master node of a component fault at one of the slave nodes.

79. The computer program of claim 72, wherein the machine-readable code comprises periodic communications code.

80. The computer program of claim 79, wherein periodic communications code comprises timed status-check code adapted to transmit a timed-response request to at least one of the slave nodes.

81. The computer program of claim 80, wherein timed status-check code comprises error-handling code for a problematic component at the at least one slave node.

82. The computer program of claim 81, wherein the error-handling code comprises mode-changing code adapted to change the at least one slave node to a safe state if the at least one slave node does not respond to the timed-response request as requested.

83. The computer program of claim 80, wherein the timed status-check code comprises error-notification code adapted to notify the master node of an error if the at least one slave node does not receive the periodic status message from the master node.

84. The computer program of claim 72, wherein the operational-management code comprises:
component control code adapted to transmit a desired command to one of the slave nodes; and
command verification code adapted to request a command verification from the slave node.
